(19) United States
(12) Patent Application Publication
(10) Pub. No.: US 2010/0065220 A1
(43) Pub. Date: Mar. 18, 2010

(54) RECYCLABLE ADHESIVE TAPE DISPENSING PRODUCT

(76) Inventors: Diane L. Walsh, North Olmsted, OH (US); Chanseol Chung, Chagrin Falls, OH (US); Curtis P. Taylor, Moreland Hills, OH (US)

Correspondence Address: FAY SHARPE / SHURTECH, 1228 Euclid Avenue, 5th Floor, The Halle Building, Cleveland, OH, 44115, US

(21) Appl. No.: 12/556,337

(22) Filed: Sep. 9, 2009

(30) Foreign Application Priority Data
Mar. 3, 2008 (US) PCT/US2008/055639

(51) Int. Cl. B29C 65/52

(52) U.S. Cl. 156/527

(57) ABSTRACT

A tape dispenser includes a roll of tape including a tape core and a length of tape wound about the tape core in several turns. A housing defines an interior and is configured to rotatably support the roll of tape. A tape cutter is supported on the housing and is adapted to cut a length of tape from the roll of tape. The housing and the tape cutter are formed from biodegradable and recyclable materials.

This application claims priority to and the benefit of the filing date of International Application No. PCT/US2008/055639, filed 3 Mar. 2008, which application claims priority to and the benefit of the filing date of U.S. Provisional Patent Application Ser. No. 60/894,103, filed 9 Mar. 2007, and U.S. Provisional Patent Application Ser. No. 60/894,137, filed 9 Mar. 2007, all of which are hereby incorporated by reference into the specification of this application.

### FIELD OF THE INVENTION

The present invention relates to adhesive tape products and more particularly to a consumer or stationery adhesive tape product comprising a roll of adhesive tape on a dispenser with a cutter for severing pieces of adhesive tape for use by the consumer.

### BACKGROUND OF THE INVENTION

Pressure sensitive adhesive tape products are widely used in packaging, in offices, in the home and elsewhere. Adhesive tape is often sold as a roll of many layers of tape wound on a cylindrical core. The core is often paper or plastic. One popular adhesive tape product comprises a dispenser having at least one side wall, a hub attached to the side wall, a roll of adhesive tape rotatably mounted on the hub and a cutter allowing an end user to remove selected lengths of adhesive tape from the roll of adhesive tape and cut them off for use. A frequently encountered version of this product has a plastic housing forming a side wall and hub and supporting a metal or plastic cutter. A roll of tape is supported on the hub. This product is sold as a disposable adhesive tape dispenser in many large retail stores. The product is often sold mounted on a paperboard merchandiser which is in turn mounted on horizontally extending pegs or upon shelves. A consumer purchases this product, removes at least a portion of the card board merchandiser and throws it away and retains the dispenser for use as needed. Tape is dispensed until the tape is exhausted and the dispenser is then discarded.

The above described example of an adhesive tape product is used widely by retail consumers and also used in office situations and elsewhere. Many people, retailers and organizations like the convenience and low cost of this product. There is no need to purchase an expensive, reusable dispenser. The product is compact and easy to use. The product is familiar. However, there are difficulties with this product. Once the tape is exhausted, the left over dispenser often includes several different components. There is a plastic housing, a tape core attached to the plastic housing which is either a paper core or a plastic core. If it is a plastic core, the core often has the appearance of being a different kind of plastic from the plastic used in the housing. The housing also usually has a cutter. Sometimes this cutter is merely a sharpened edged on the plastic housing. Sometimes this cutter is metal. A portion of the paperboard merchandiser is also often retained with the housing as one of the side walls. Thus, the finished product has components of different types and is therefore not easily recyclable. Because of this, it is often thrown in the trash.

Many consumers and business organizations are concerned with the creation of waste products and wish to minimize waste products by recycling. Recycling is encouraged by some governmental organizations and business organizations by the provision of recycling containers. Such containers are often marked to encourage deposit of particular recyclable items. Thus, a container may be marked for aluminum cans. Other receptacles are marked for paper recycling.

Some plastics are also recycled. Some plastic products are marked with a recycle marking including a number indicating the type of plastic as different plastics are recycled in different ways. Thus, various materials are often separated one from the other in a successful recycling effort. Products containing a mix of material are therefore difficult to recycle.

Most plastics are made from oil or natural gas. The excessive consumption of oil and natural gas is viewed negatively by many people. Many plastics do not easily degrade. When disposed of, for instance in a landfill, many plastics will retain their integrity for many years.

Consumers and retailers have also become conscious of the amount of packaging associated with a product. Moreover, packaging adds cost to a product. The handling of the packaging at the retail level adds costs to the distribution of a product. The handling and disposal of packaging by the consumer adds inconvenience to products.

### SUMMARY OF THE INVENTION

The present invention contemplates a new and improved adhesive tape dispensing product which overcomes the above-referred to problems and others. The present invention provides a roll of tape on a tape dispenser which is inexpensive to manufacture, uses a minimum of packaging materials, provides a convenient tape dispensing experience to the consumer, and is easily recyclable upon the exhaustion of the tape.

Briefly stated, in accordance with the invention, there is provided an adhesive tape dispensing product comprising a dispenser having at least one side wall, the dispenser being adapted to support a roll of tape. A cutter is also supported by the side wall and is adapted to cut tape from the roll of tape. The tape dispenser, including the side wall and cutter, is exclusively, or for the most part, paperboard, molded pulp, molded cornstarch, polylactides, starch based polymers, other paper based material and/or combinations thereof. Upon the exhaustion of the length of adhesive tape, the adhesive tape dispensing product may be recycled as a paper recyclable. Variations of the invention include some removable non-paperboard elements, such as a plastic core which can be removed prior to recycling.

Further in accordance with the invention, the dispenser is biodegradable.

Further in accordance with the invention, the tape cutter is a non-metallic tape cutter having a hard edge comprised of molded cornstarch, polylactides, starch based polymers and/or other paper like material.

Yet further in accordance with the invention, the dispenser side wall, the dispenser hub (if present) and all parts of the dispenser are exclusively paperboard, molded pulp, polylactides, starch based polymers, and/or molded cornstarch or combinations thereof whereby the entire dispenser is recyclable as a paper recyclable.

Yet further in accordance with the invention, the tape core is polylactide or other starch based polymer or a paper tape core whereby once the body of tape is exhausted, the remnants of the roll of tape may be recycled as a paper recyclable.

Further in accordance with the invention, the merchandiser card is sometimes manufactured as part of the dispenser.

Further in accordance with the present invention, packaging is integrated into the dispenser portion of the product minimizing packaging costs, minimizing packaging, and making the packaging recyclable as a paper product by the consumer. The portion of the packaging, the display card, which can be separated from the dispenser, is easily recycled as a paper recyclable.

Applicants have found that a tape dispenser product comprised primarily of paperboard and molded pulp with the addition of a biodegradable polymer cutter is economical to manufacture, has a sufficient lifetime for its intended purpose, can be made so the dispenser is recyclable as a paper product and can be made so the dispenser is biodegradable.

If the dispenser is recycled, it may be entirely recycled as a paper product. if the dispenser is not recycled but discarded, and finds it way to a landfill, it will biodegrade as a paper/biodegradable material in a favorable manner and relatively short time.

If the tape core is also a paper or biodegradable polymer, preferably a polylactide, then the entire product residue after exhaustation of the tape is recyclable as a paper product and biodegradable.

It is a principle object of the present invention to provide an adhesive tape dispensing product which is inexpensive to manufacture, can be merchandised with a minimum of packaging, can be easily and conveniently used by the consumer as a source of discrete pieces of tape, and which can be easily recycled upon exhaustion of the tape.

It is a further object of the present invention to provide a recyclable adhesive tape dispensing product in which all or most of the elements except the adhesive tape itself are recyclable as paper recyclables.

It is still another object of the present invention to provide an adhesive tape dispensing product which has a familiar look to the consumer, which will be intuitively easy to use, and which is easily merchandisable.

It is another object of the present invention to provide a packaged adhesive tape dispensing product which introduces a minimum of materials into the waste product stream and uses a minimum of packaging.

It is another object of the invention to provide a tape dispensing product using a minimum of non degradable materials.

These and other objects and advantages of the present invention will become apparent from the following detailed description of the preferred embodiments and from the accompanying drawings in which:

### BRIEF DESCRIPTION OF THE DRAWINGS

FIG. 1 is an exploded perspective view of an exemplary tape dispenser according to one aspect of the present disclosure.

FIG. 2 is a front perspective view of the exemplary tape dispenser of FIG. 1.

FIG. 3 is a rear perspective view of the exemplary tape dispenser of FIG. 1.

FIG. 4 is a front elevational view of a side wall for the exemplary tape dispenser of FIG. 1.

FIG. 5 is a rear elevational view of the side wall of FIG. 4.

FIG. 6 depicts the exemplary tape dispenser of FIG. 1 mounted on a known display.

FIG. 7 is a perspective view of an exemplary tape dispenser according to another aspect of the present disclosure.

FIG. 8 is an exploded perspective view of the exemplary tape dispenser of FIG. 7.

FIG. 9 is a front perspective view of the exemplary tape dispenser of FIG. 7.

FIG. 10 is a cross-sectional view of the exemplary tape dispenser of FIG. 9 taken generally along line 10-10 of FIG. 9.

FIG. 11 is a front perspective view of an exemplary tape dispenser according to yet another aspect of the present disclosure.

FIG. 12 is an exploded perspective view of the exemplary tape dispenser of FIG. 11.

FIG. 13 is a cross-sectional view of the exemplary tape dispenser of FIG. 11 taken generally along line 13-13 of FIG. 11.

### DESCRIPTION OF THE PREFERRED EMBODIMENTS

Referring now to the drawings wherein the showings are for the purposes of illustrating preferred embodiments of the invention only and not for the purposes of limiting same, the drawings show a variety of tape dispensing products having some unifying characteristics. One unifying characteristic is the choice of materials used. These materials will be described in more detail here to simplify the description of the structure of the preferred embodiments hereinafter.

Some elements of the preferred embodiments are paperboard elements. Paperboard is generally a planar material fabricated primarily from wood pulp, recycled paper and the like and having a thickness and stiffness greater than ordinary writing paper. Consumers sometimes refer to paperboard as cardboard. Examples of paperboard include the cards upon which many consumer products are mounted for display on hooks at retail stores. Paperboard is also often used for packaging of clothing items such as shirts, ties, blouses, and the like. Paperboard is recyclable as a paper product. Paperboard often bears pertinent information printed on one or both faces.

Corrugated board is another paper-based product consisting of two flat sheets of paper with a corrugated or “wavy” sheet of paper between them. The three sheets of paper are glued together forming a stiff board often seen as boxes. The three sheets of paper are often glued together by means of a glue based on cornstarch. Corrugated board is a paper product and is recyclable as a paper product. This includes the corn-based adhesive used to bind the paper sheets together.

Molded pulp is another packaging material often made from recycled paper products or other wood fiber material. Examples of molded pulp include egg cartons and beverage carriers often distributed at coffee shops and fast food outlets when a patron purchases more than two cups of coffee to go. Molded pulp products often have a thickness of 1/16 inch or greater and are relatively stiff. Molded pulp products are often used in place of foamed plastic in packaging and in other similar applications. Molded pulp products are recyclable as paper products. Paperboard, molded pulp and paper products are also biodegradable. In a favorable environment, paper products, such as paperboard and molded pulp will biodegrade in less than one year.

Cornstarch is a vegetable product which can be processed into food products, adhesives, and many other products. Cornstarch based adhesives are used in corrugated board. Therefore, cornstarch is an expected and accepted material in paper recycling.

Biodegradable polymers are commercially available. One group of biodegradable polymers is known as polylactides or polylactic acid polymers. These polymers are often made from vegetable based materials such as cornstarch. They are sometimes referred to as “PLA” polymers. These polymers may be fabricated into relatively stiff shapes capable of cutting such as disposable tableware. Products fabricated from these materials will maintain their physical integrity for reasonable periods of time until placed in an appropriate biodegradation environment, such as a compost facility, where the actions of bacteria and the like degrade the material primarily into water and carbon dioxide. In ideal situations, this breakdown can be completed in a matter of months.

Because PLA materials are based on cornstarch or other vegetable based materials (e.g. sugar cane) they do not chemically contaminate a recycle process. There are other similar biodegradable polymers including polyhydroxybutyrate but PLAs are the biodegradable polymer group for use in the present invention. Polylactide polymers are relatively expensive materials, especially when compared to paperboard and molded pulp.

The above described materials are used in consumer products throughout the United States and indeed the world. These products are commercially available from a number of sources. Paper and molded pulp products are relatively inexpensive and can be processed by many conventional means. Biodegradable polymers can also be fabricated in many conventional ways. These products, when not contaminated or mixed with improper elements, can all be recycled as paper products without disrupting the recycling process.

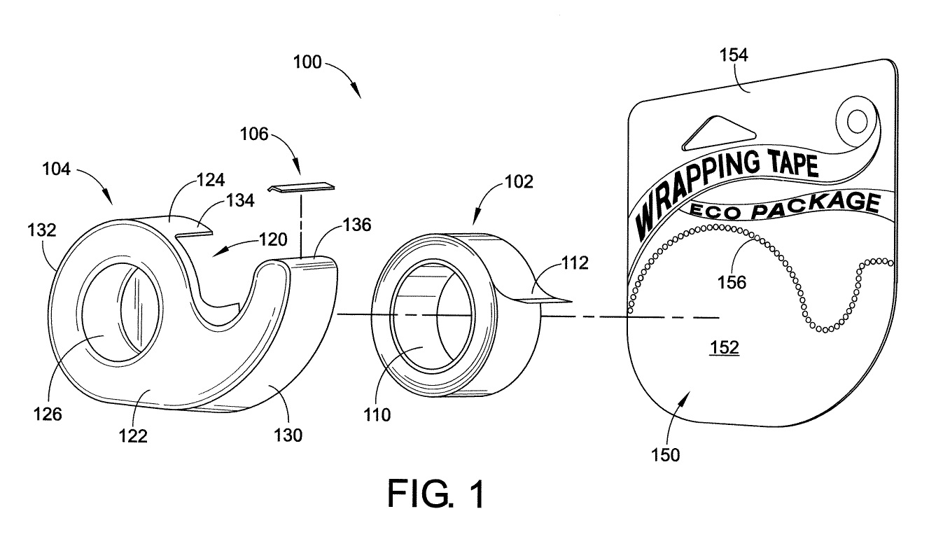

Referring now to the drawings, wherein like numerals refer to like parts throughout the several views, FIGS. 1-3 depict an exemplary tape dispenser 100 according to one aspect of the present invention. The tape dispenser comprises a roll of tape 102, a housing 104 and a tape cutter 106. The roll of tape includes a tape core 110 and a length of tape 112 wound about the tape core in several turns. The housing 104 defines an interior 120 and is configured to rotatably support the roll of tape 102. The tape cutter 106 is supported on the housing 104 and is adapted to cut the length of tape 112 from the roll of tape 102. As will be discussed in greater detail below, each component of the tape dispenser 100 is formed from biodegradable and recyclable materials whereby, upon the exhaustion of the length of adhesive tape, the adhesive tape dispenser 100 may be recycled as a paper recyclable.

The roll of tape 102 comprises the tape core 110 upon which is wound the length of adhesive tape 112 for dispensing. The length of tape is at least partially formed of pulp and cotton fibers. The tape core 110 is generally a cylinder of recycled paper, such as thick paperboard, or a plastic part with an outer cylindrical surface. Plastic tape cores are often used for stationery type transparent tape as a means of controlling telescoping. Paper tape cores are often used on wider tapes, such as two inch packaging tape; although, it should be appreciated that a paper core can be used with the depicted small size adhesive tape roll 102. In some exemplary embodiments, a plastic core may be used as it is easily separated from the remaining portions of the tape dispenser for recycling. However, it is contemplated that cores fabricated from recycled paper or PLA materials will have the shape and features necessary to address the telescoping issues normally addressed with a plastic core. Thus, it is contemplated to use both plastic cores and recyclable, biodegradable, PLA cores as well as paper cores for the roll of tape 102.

With reference to FIGS. 1-3, the housing 104 is a unitary component formed of molded pulp. The molded pulp housing 104 includes a side wall 122, a peripheral wall 124 and a hub 126. The peripherally wall is a continuous element forming a bottom wall 130, a generally curved back wall 132, a generally curved top wall 134, and a cutter support 136. The hub 126 extends from the side wall 122 and is adapted to rotatably receive the tape core 110. The top of the tape dispensing housing 104 is mostly open. This provides access to the length of tape 110 extending from the roll of tape 102 to the tape cutter 106. A user may insert a finger under this length of tape, lift the end of the length of tape off the cutter 106 and pull the length of tape off the roll of tape. When an appropriate length of tape is extended, the length of tape is brought down against the cutter and separated from the rest of the roll. This action and this appearance very closely resembles that of a conventional tape cutter and is intuitively obvious to most users.

The tape cutter 106 is fixed upon the cutter support 136 at its front edge. According to one aspect, the cutter is a rigid flat piece with a serrated sharp leading edge. When a user has dispensed a desired length of tape, the tape 110 is brought into contact with the tape cutter 106 and the tape piece or segment is cut off. The remaining end portion of the tape 110 will lightly stick to the surface of the tape cutter or the cutter support retaining the end of the tape ready for the next application. In the exemplary embodiment, the tape cutter 106 with a sharp serrated leading edge is made from recycled materials, such as sawdust and wood (e.g., bamboo) fibers; although other materials can be used. Any paper recyclable material resulting in a sharpenable rigid planar element capable of holding a sufficient edge to cut tape may be used. The tape cutter 106 can also be formed from a PLA material or another corn starch based recyclable material which can be recycled with paper. According to another aspect, the cutter can be integrally formed with the housing 104. Alternatively, a metal or other non-paper cutter may be placed on the cutter support 136 of the dispensing housing 104. When the tape is exhausted, this cutter can be ripped away from the rest of the tape dispenser 100, discarded as a mixed item, and the rest of the tape dispenser and tape core can be recycled as a paper product.

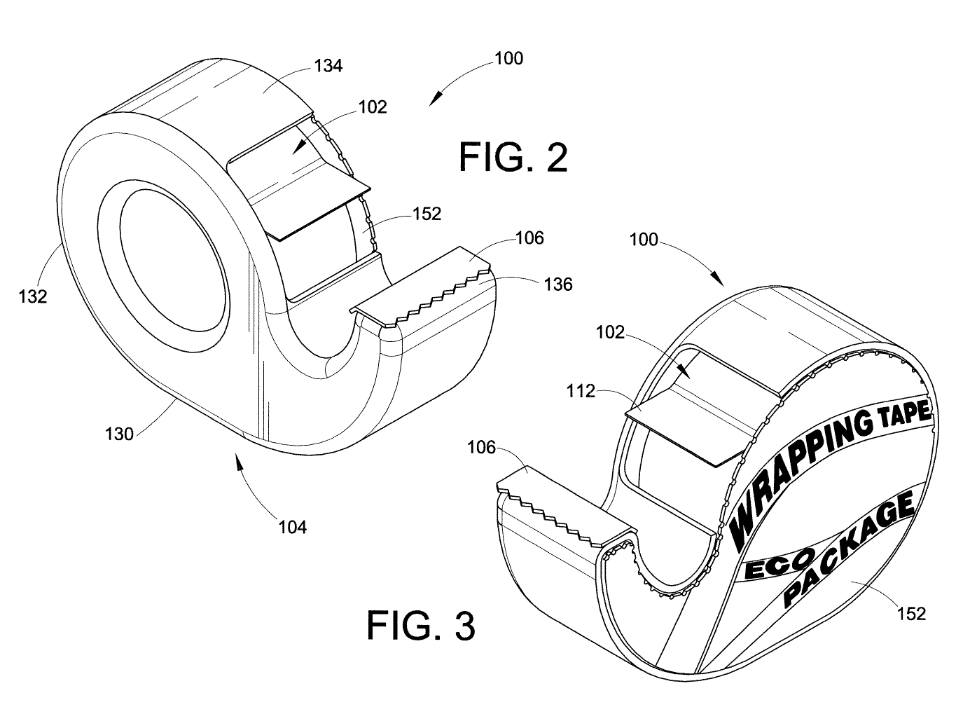

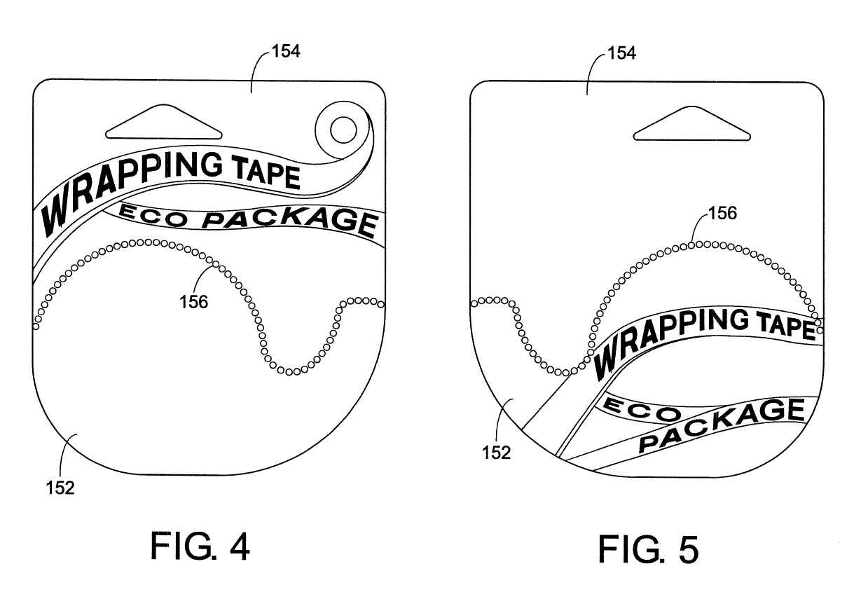

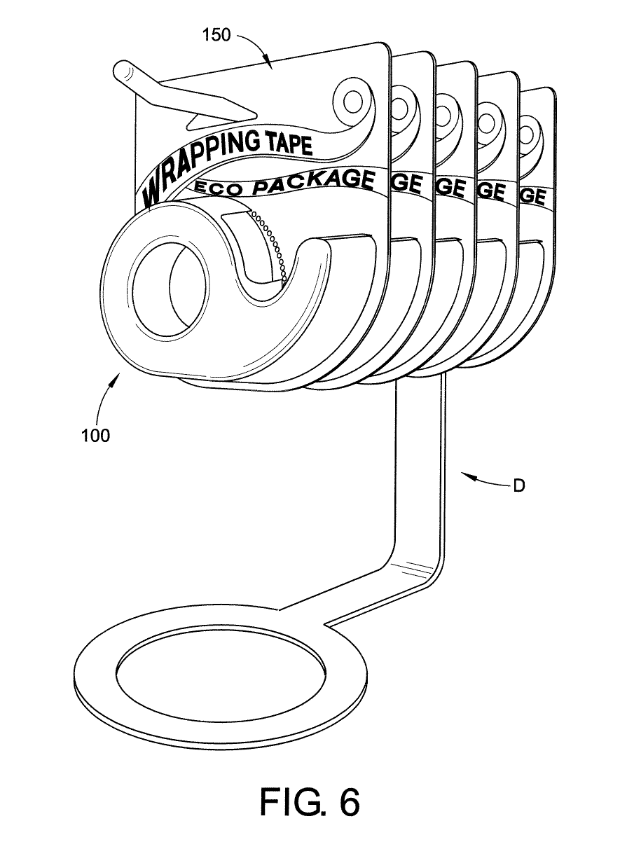

According to one aspect, the tape dispenser 100 can further comprise a side wall 150 formed of recycled paper. As shown in FIGS. 4 and 5, the side wall includes a cover portion 152 and a merchandising display portion 154, which is separable from the cover portion via a perforation 156 traversing the side wall. The cover portion 152 has a shape substantially mirroring a shape of the side wall 122. Thus, as shown in FIGS. 2 and 3, the cover portion is configured to cover the interior 120 of the housing 104. This secures the tape roll 102 within the housing. To assembly the tape dispenser 100, the roll of tape 102 is placed upon the hub 126, the cutter 106 is fixed upon the cutter support 136 and the cover portion 152 of the paperboard side wall 150 is glued or otherwise fixed to the end of the hub 126, closing the interior 120 of the tape dispenser. The end of the body of tape 112 extends from an opening 160 in the top wall of the dispenser and can be fed over the cutter support 136 and cutter 106.

The tape dispenser 100 is manufactured with the separate paperboard side wall 150 such that the merchandising display portion 154 is integral with and separable from the cover portion 152, which at least partially forms the dispenser housing 104. With this configuration, manufacturing costs and material part count are minimized. As shown in FIG. 6, the depicted tape dispenser 100 visually strongly resembles a conventional multi-element non-recyclable tape dispenser and can be merchandised easily on a display D. The depicted tape dispenser 100 is self merchandising in that the retail product is simply hung on the display D with appropriate indicia on the merchandising display portion 154 ready for purchase by the consumer. When a consumer purchase this product, the consumer may remove the merchandising display portion 154 of the paperboard side wall 150 and recycle it as a paper product. The consumer is left with a conventional appearing tape dispenser with the end of the tape extending from the housing 104 ready to be fed over the cutter 106 and used as needed. When the tape 112 is exhausted, a paper recyclable tape dispenser is left. This implementation minimizes the need for packaging and also provides a homogenous product and package.

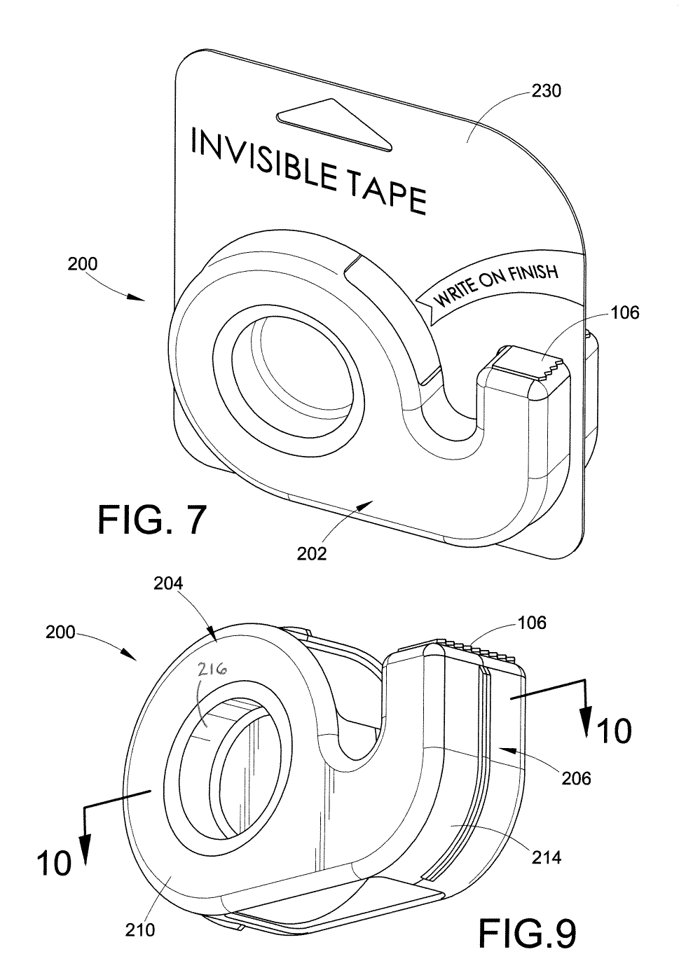

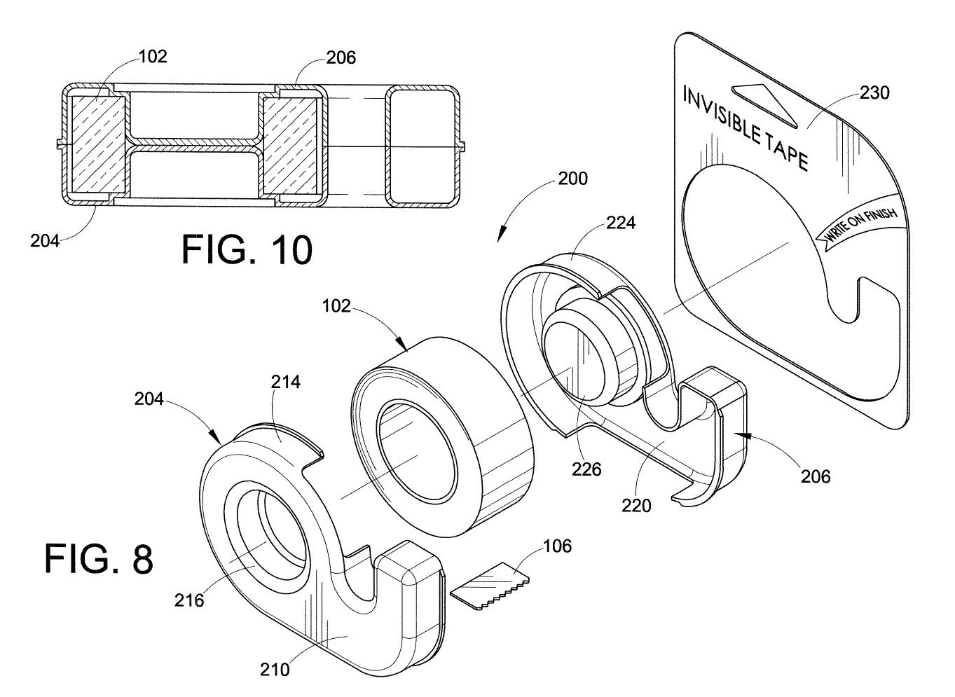

Alternatively, as shown in FIGS. 7-10, according to another aspect of the present invention, instead of implementing side wall 150, an exemplary tape disperser 200 can further comprise a housing 202 including first and second housing parts 204, 206, each being formed of molded pulp. The first housing part includes a side wall 210, a peripheral wall 214 and a hub 216. The hub 216 extends from the side wall 210 and is adapted to rotatably receive the tape core 110. The second housing part 206 is a mirror image of the first housing part 204 and includes a side wall 220, a peripheral wall 224 and a hub 226. The two hubs 216, 226 have a smaller axial dimension such that when the first and second housing parts 204, 206 come together, the hubs 216, 226 together rotationally support the roll of tape 102. According to another aspect, the second housing part 206 does not include a hub. In this exemplary embodiment, the roll of tape 102 is solely supported by hub 216 which has an elongated axial dimension. The molded pulp components 204, 206 may be joined at an edge or separately formed and adhered together. A separate paperboard merchandising display 230 is provided so that the tape dispenser 200 can be merchandised easily on the display D. Similar to tape dispenser 100, when a consumer purchase this product, the consumer may remove the merchandising display 230 and recycle it as a paper product. The consumer is again left with a conventional appearing tape dispenser with the end of the tape extending from the housing 202 ready to be fed over the cutter 106 and used as needed. When the tape is exhausted, a paper recyclable tape dispenser is left.

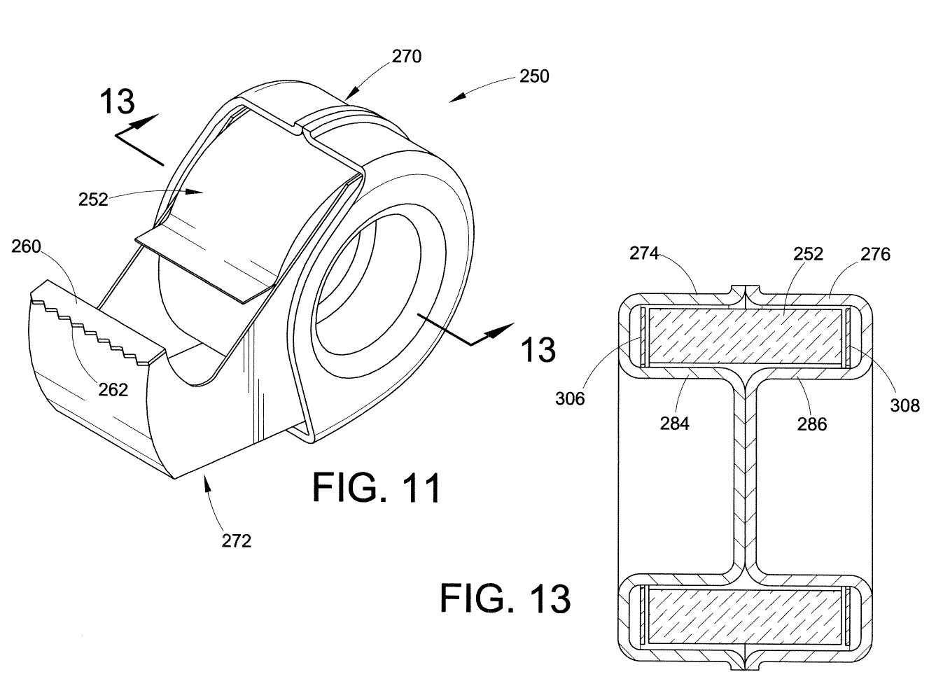

With reference to FIGS. 11-13, another exemplary tape dispenser 250 of the present invention is illustrated. Similar to previously described tape dispensers, tape dispenser 250 comprises a roll of tape 252 having a tape core 254 with a body of tape 256 rolled upon the core and a tape cutter 260 with a serrated forward edge 262. Both the roll of tape and the cutter are formed of recyclable and biodegradable materials, whereby each is recyclable as a paper product. The tape dispenser 250 further comprises a housing 264 having a first housing part 270 and a second housing part 272 at least partially received within the first housing part. According to one exemplary embodiment, the first housing part 270 can be formed from molded pulp and the second housing part 272 can be formed from paperboard.

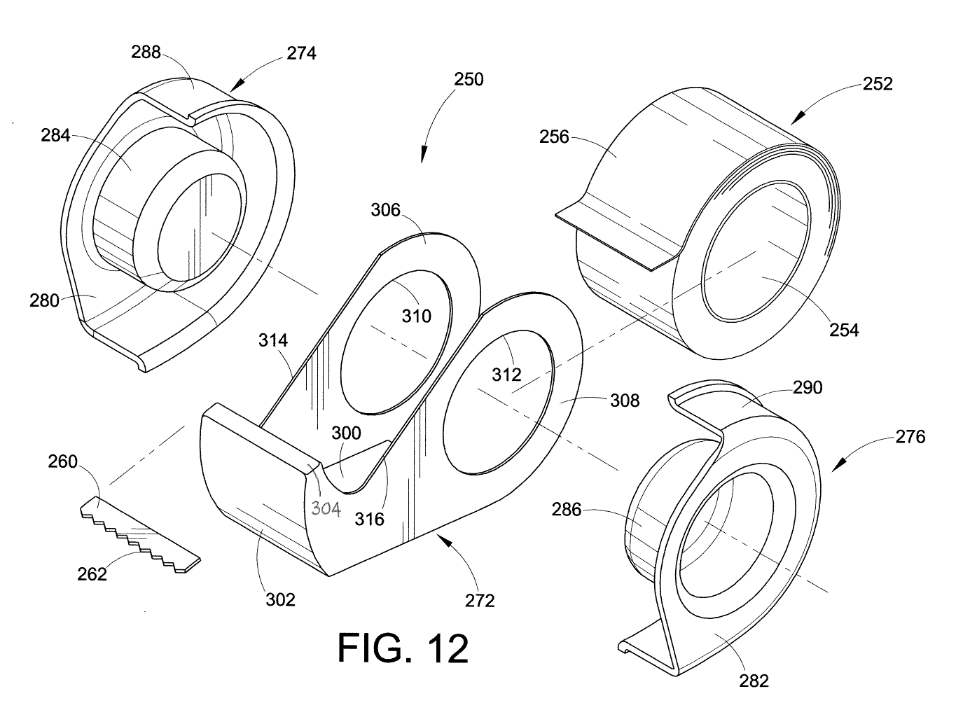

As shown in FIG. 12, the first housing part 270 includes a first portion 274 and a second portion 276 which is a mirror image of the first portion. The molded pulp first and second portions may be joined at an edge or separately formed. Each portion 274, 276 includes a sidewall 280, 282 having an inwardly facing protrusion or dimple 284, 286 and a truncated outer wall 288, 290. The second housing part 272 can be fabricated from a single blank of paperboard and has a flat bottom wall 300, a curved forward wall 302, a generally rectangular top wall 304 for supporting the tape cutter 260 and two side walls 306, 308 which are mirror images one of the other. Each side wall 306, 308 has a circular opening 310, 312 near its rear end and a top edge 314, 316 which starts high over the circular opening and tapers downwardly toward the tape cutter and then back up to the tape cutter 260. This provides a volume under a length of tape extending from the tape roll 252 to the cutter into which a user can extend a finger to grasp a piece of tape.

To form the tape dispenser 250, the roll of tape 252 is aligned in the second housing part 272 with the core 254 aligned with the openings 310, 312 in the side walls 306, 308. The two dimples 284, 286 pass through the openings 310, 312 and into the tape core 254 to loosely retain the roll of tape. This retention prevents the roll of tape from spilling out of the open top, but otherwise allows the roll of tape to freely rotate. The dimples are adhered to one another which holds the first and second housing parts and the roll of tape together. Similar to the previously described tape dispensers, tape dispenser 250 is entirely paper recyclable or almost entirely paper recyclable. In a completely recyclable implementation, the tape cutter 260 is fabricated from PLA polymers, or other materials which are recyclable as paper. The tape core 254 can be PLA or paper. The length of tape can be at least partially formed of pulp and cotton fibers. In a mostly recyclable implementation, either a plastic or metal tape cutter is used and a plastic tape core is used, both of which can be removed from the paperboard dispenser for recycling.

Adhesive tape dispensers comprised of housing and merchandising elements fabricated from paper and paper-like materials and biodegradable polymers have been described in numerous implementations. The products provide a convenient, familiar tape dispenser to consumers with the advantages of conventional tape dispensers plus the advantage of recyclability of the merchandising materials and dispenser once the tape is fully dispensed. Biodegradability is also provided Plastic elements and metal elements are minimized or avoided entirely. Easily recyclable paper based elements are used at every opportunity.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A tape dispenser comprising.
a roll of tape including a tape core and a length of tape wound about the tape core in several turns;
a housing defining an interior and configured to rotatably support the roll of tape; and
a tape cutter supported on the housing and adapted to cut a length of tape from the roll of tape;
wherein the housing and the tape cutter are formed from biodegradable and recyclable materials.

2. The tape dispenser of claim 1, wherein the housing is a unitary component formed at least partially from molded pulp.

3. The tape dispenser of claim 2, wherein the housing includes a side wall, a peripheral wall and a hub for supporting the roll of tape, the peripheral wall being a continuous element defining a bottom wall, a generally curved back wall, a generally curved top wall, and a cutter support.

4. The tape dispenser of claim 1, wherein the tape cutter is formed from one of recycled paper products and wood fiber material.

5. The tape dispenser of claim 1, wherein the housing includes a first housing part and a second housing part connected to the first housing part, the second housing part being a mirror image of the first housing part.

6. The tape dispenser of claim 1, wherein the tape core and the length of tape are formed of biodegradable and recyclable materials, whereby each is recyclable as a paper product.

7. The tape dispenser of claim 6, wherein the tape core is formed from one of paperboard and polylactide, and the length of tape is at least partially formed of pulp and cotton fibers.

8. The tape dispenser of claim 1, further comprising a separate side wall connected to the housing, the side wall being at least partially formed of paperboard, the side wall having a cover portion and a merchandise display portion, the cover portion being separable from the merchandise display portion, wherein the cover portion is configured to cover the interior of the housing, the cover portion securing the tape roll within the housing.

9. The taper dispenser of claim 1, wherein the housing includes a first housing part and a second housing part at least partially received within the first housing part, the first housing part being formed from molded pulp and a second housing part being formed from paperboard.

10. The taper dispenser of claim 10, wherein the first housing part includes a pair of opposed sidewalls, each sidewall having a dimple, the second housing part includes opposed side walls, each side wall having an opening dimensioned to receive one of the dimples, wherein the dimples pass through the openings and together form a hub for supporting the tape roll.

11. The tape dispenser of claim 1, wherein the housing includes a first housing part and a second housing part, each housing part includes a side wall and a peripheral wall, at least one of the housing parts includes a hub for rotatably supporting the roll of tape, the first and second housing parts being formed of molded pulp.

12. A recyclable adhesive tape dispensing product comprising:
a housing including a side wall and a hub extending from the side wall and being adapted to support a roll of adhesive tape;
a tape core rotatable supported on the hub;
a length of adhesive tape wound upon the tape core in several turns, the core and the length of tape forming a roll of adhesive tape; and
a tape cutter supported on the housing and adapted to cut a length of tape from the roll of adhesive tape;
wherein the housing, tape core and cutter all being exclusively formed of a biodegradable and recyclable material whereby, upon the exhaustion of the length of adhesive tape, the adhesive tape dispensing product may be recycled as a paper recyclable.

13. The tape dispenser of claim 12, wherein the housing is a unitary component formed of molded pulp.

14. The tape dispenser of claim 12, wherein the tape cutter is formed from recycled wood fiber material and the tape core is formed of recycled paperboard.

15. The tape dispenser of claim 12, wherein the length of tape is at least partially formed of pulp and cotton fibers.

16. The tape dispenser of claim 12, further comprising a separate side wall connected to the housing, the separate side wall being at least partially formed a recycled material, the side wall having a cover portion and a merchandise display portion, the cover portion being separable from the merchandise display portion and having a shape substantially mirroring a shape of the housing side wall.

17. The tape dispenser of claim 12, wherein the housing includes a first housing part and a second housing part, the first and second housing parts being mirror images of each other, the first and second housing parts defining an interior for receiving the tape roll, each housing part being formed of a molded pulp.

18. An improved adhesive tape dispenser product comprising:
a housing including a first housing part and a second housing part connected to the first housing part, at least one of the housing parts includes a sidewall, a cutter support and a hub for rotatably supporting a roll of tape;
a cutter supported by the cutter support; and
the roll of tape comprising a core and a length of adhesive tape wound upon the core, the roll of tape being retained at least partially within the housing;
wherein each component of the tape dispenser is formed from a biodegradable and recyclable material, whereby the entire tape dispenser is recyclable as a paper product.

19. The tape dispenser of claim 18, wherein the first and second housing parts are mirror images of each other, each housing part being a unitary component formed at least partially from molded pulp.

20. The tape dispenser of claim 18, wherein the tape cutter is formed from recycled wood fiber material and the tape core is formed of recycled paperboard.
